(19) United States
(12) Patent Application Publication
(10) Pub. No.: US 2005/0000582 A1
(43) Pub. Date: Jan. 6, 2005

(54) Fuel hose

(75) Inventors: Yoshio Okado, Komaki-shi (JP); Hideki Shinohara, Komaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/693,862

(22) Filed: Oct. 28, 2003

(30) Foreign Application Priority Data
Oct. 28, 2002 (JP) JP2002-313158
Oct. 28, 2002 (JP) JP2002-313159

(51) Int. Cl. F16L 11/00

(52) U.S. Cl. 138/137; 138/DIG. 3; 428/36.91

(57) ABSTRACT

A fuel hose which has excellent permeation resistance to gasoline, sour gasoline resistance, amine resistance and low temperature properties, and has excellent electrical conductivity. The fuel hose has a laminate structure comprising an innermost layer made of the rubber blend (A) of an acrylic rubber and an acrylonitrile-butadiene rubber wherein acrylonitrile is present in a proportion of 15 wt % to 30 wt %, or an acrylic rubber (B) having a skeleton derived from acrylonitrile in its molecular skeleton, and a fluororesin layer formed on a peripheral surface of the innermost layer.

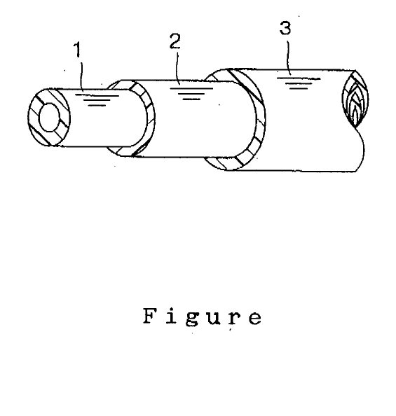

### BACKGROUND OF THE INVENTION

1. Field of the Invention

The present invention relates to a fuel hose for transporting fuels such as gasoline, alcohol-containing gasoline (gasohol), alcohol, hydrogen, light oil, dimethyl ether, liquefied petroleum gas (LPG), compressed natural gas (CNG) or the like.

2. Description of the Art

With growing worldwide awareness of environmental issues, the control of the amount of hydrocarbon vapor emission from an automotive fuel hose has been enhanced. Particularly in the United States, stringent regulations against vapor emission have come into effect. To cope with the hydrocarbon vapor emission control in this situation, multi-layer hoses have been proposed which include a rubber layer, a resin layer, a reinforcing layer and the like. Such a multi-layer hose generally uses a polyamide resin, acrylonitrile-butadiene rubber (NBR), a nitrile-polyvinyl chloride rubber (NBR -PVC), a fluororesin and the like as a material for the innermost layer in terms of providing excellent resistance to fuel oils.

However, a polyamide resin is insufficient in resistance to sour gasoline which is the result of oxidation of gasoline (sour gasoline resistance being particularly important in applications to fuels). Similarly, NBR is also insufficient in sour gasoline resistance. NBR•PVC contains PVC, which may deteriorate the environment, and has poor low temperature properties, and further is not conformable to the above-mentioned regulations against vapor emission.

To improve permeation resistance to gasoline, multi-layer hoses including a fluororesin layer have been proposed. For example, a hose having the innermost layer made of a fluororesin has a poor sealing property and also is difficult to join with other parts due to its rigidity, which may result in leakage of fuel and the like. However, if a hose is produced by forming an innermost layer comprising NBR or a fluororubber (FKM) on an inner peripheral surface of the fluororesin layer, such a hose has good permeation resistance to gasoline (barrier properties to gasoline and gasohol) due to the fluororesin layer and also has a good sealing property due to NBR or FKM (see, for example, Japanese Unexamined Patent Publication No. 08-169085).

However, if such a hose as proposed in the above-mentioned Publication adopts an innermost layer of NBR, the resulting hose is drastically deteriorated in sour gasoline resistance, as mentioned above. Alternately, if such a hose as proposed in the same Publication adopts an innermost layer of FKM, an adhesive property between the FKM and a fluororesin layer is bad, which requires interlaminar bonding by means of an adhesive, resulting in complicated production and an possible increase in its production cost. Further, since the latter hose has an inferior low-temperature property (a sealing property when in use at an extremely low temperature (about −30° C.)), improvement has been highly demanded.

In addition, it is very important for a fuel hose to have an electrical conductivity to dissipate static electricity, generated by a fuel pump, from the hose to outside the hose so as to help prevent accidents such as ignition of a fuel (such as gasoline) which may otherwise occur due to the static electricity. However, in a hose having the innermost layer made of FKM, since FKM itself has substantially high electrical resistance, it is difficult to impart sufficient electrical conductivity, even with the addition of an electrically conductive agent such as carbon black. Alternately, if an amount of an electrically conductive agent blended is increased so as to impart sufficient electrical conductivity, the mechanical strength of the innermost layer is decreased, which may result in a deterioration in the sealing property. Therefore, an innermost layer excellent at both electrical conductivity and sealing property has been greatly demanded even if such an electrically conductive agent is not added.

In view of the foregoing, it is an object of the present invention to provide a fuel hose which has excellent permeation resistance to gasoline, sour gasoline resistance, amine resistance and low temperature properties, and has excellent electrical conductivity.

### SUMMARY OF THE INVENTION

In accordance with a first aspect of the present invention to achieve the aforesaid object, there is provided a fuel hose having a laminate structure comprising an innermost layer made of the following (A) and a fluororesin layer formed on a peripheral surface of the innermost layer:

(A) a rubber blend of an acrylic rubber (ACM) and an acrylonitrile-butadiene rubber (NBR) wherein acrylonitrile is present in a proportion of 15 wt % to 30 wt %.

In accordance with a second aspect of the present invention to achieve the aforesaid object, there is provided a fuel hose having a laminate structure comprising an innermost layer made of the following (B) and a fluororesin layer formed on a peripheral surface of the innermost layer:

(B) an acrylic rubber having a skeleton derived from acrylonitrile in its molecular skeleton.

The inventors of the present invention, in conducting studies to solve the above mentioned problems, focused upon the innermost layer of a fuel hose. During the investigative process, the inventors recognized an acrylic rubber as a material having better low temperature properties than NBR or FKM, excellent sour gasoline resistance and good electrical conductivity. However, since an ordinary acrylic rubber is inferior in resistance to a fuel oil compared with NBR or FKM, it has been a technically common sense that such an acrylic rubber is not suitable for use as an innermost layer of a fuel hose. As a result of intensive studies for improving the resistance to a fuel oil while retaining the originally excellent properties, such as low temperature properties, derived from an acrylic rubber, the inventors found that when an innermost layer was made of the above mentioned rubber blend (A) of ACM and NBR where the content of acrylonitrile is adjusted to a specified proportion by use of bound acrylonitrile derived from NBR, improved resistance to a fuel oil was confirmed while retaining good low temperature properties and good electrical conductivity and the like. Further, an adhesive property with a fluororesin, excellent in permeation resistance to gasoline, was also confirmed to such a degree as no adhesive is required for bonding therebetween according to the situation.

Further, the inventors found that when an innermost layer of a hose was made of an acrylic rubber (B) having a skeleton derived from acrylonitrile in its molecular skeleton so as to incorporate a specific amount of acrylonitrile into the molecular skeleton of the acrylic rubber, polarity is increased so as to become generally in compatible with an fuel oil having a low polarity, resulting in an improved resistance to a fuel oil while retaining good low temperature properties, good electrical conductivity and the like, and further adhesion with a fluororesin, excellent in permeation resistance to gasoline, was also confirmed to such a degree as no adhesive is required for bonding therebetween according to the situation.

Thus, the inventors have found that when a fuel hose having a laminate structure comprising an innermost layer made of the specific rubber blend (A) or the specific acrylic rubber (B), as mentioned above, and a fluororesin layer formed on a peripheral surface of the innermost layer, the above object is achieved. Thus, the present invention has been attained.

### BRIEF DESCRIPTION OF THE DRAWINGS

The sole FIGURE of the drawing is a diagram illustrating an exemplary fuel hose according to the present invention.

### DETAILED DESCRIPTION OF THE INVENTION

The present invention will hereinafter be described in detail by way of embodiments thereof.

A fuel hose according to the present invention has a multi-layer laminate structure comprising an innermost layer made of the specific rubber blend (A) or the specific acrylic rubber (B), as mentioned above, and a fluororesin layer formed on a peripheral surface of the innermost layer, which has the noticeable characteristics of the present invention.

The sole FIGURE is an example of a fuel hose according to the present invention. The inventive fuel hose has a three-layer structure comprising an innermost layer 1 made of a specific rubber blend (A) or a specific acrylic rubber (B), a fluororesin layer 2 formed on a peripheral surface of the innermost layer, and an outer layer 3 formed on a peripheral surface of the fluororesin layer, successively.

The specific rubber blend (A) for the innermost layer 1 is a rubber blend of an acrylic rubber (ACM) and an acrylonitrile-butadiene rubber (NBR), wherein acrylonitrile is present in a proportion of 15 wt % to 30 wt %, as mentioned above. Since ordinary ACM not containing acrylonitrile is used for the rubber blend (A), the whole amount of the acrylonitrile is derived from bound acrylonitrile of NBR. Acrylonitrile is introduced in ACM by blending ACM and NBR.

ACM used for the above mentioned specific rubber blend (A) is not specifically limited and various acrylic rubbers may be used, as long as the rubber does not contain acrylonitrile and consists mainly of alkyl ester acrylate and/or alkoxyalkyl ester acrylate. The expression “consists mainly of” means herein, for example, that alkyl ester acrylate and/or alkoxyalkyl ester acrylate is preferably present in a proportion of 90% or more relative to the whole amount of the specific rubber blend (A). Examples of alkyl ester acrylate include alkyl ester acrylate having 1 to 20 carbons in its alkyl group, such as methyl acrylate, ethyl acrylate, n-butyl acrylate, iso-butyl acrylate, tert-butyl acrylate, propyl acrylate, n-octyl acrylate, 2-ethylhexyl acrylate, lauryl acrylate and stearyl acrylate.

Examples of alkoxyalkyl ester acrylate include alkoxyalkyl ester acrylate having 1 to 4 carbons in its alkoxy group or its alkylene group, such as methoxymethyl acrylate, methoxyethyl acrylate, ethoxyethyl acrylate, butoxyethyl acrylate and methoxyethoxy ethyl acrylate.

ACM may include a copolymer of monomers such as ethylene, propylene and the like in addition to the above mentioned alkylester acrylate and alkoxyalkyl ester acrylate.

Further, ACM may include an active group for crosslinking, for example, epoxy group containing monomers such as arylglycidyl ether and glycidyl methacrylate; chlorine containing monomers such as 2-chloroethylvinyl ether, vinyl chloroacetate and cyclochloroacetate; unsaturated group containing monomers such as ethylidene norbornene; copolymers obtained by copolymerizing each component (monomer) containing a carboxy group such as acrylate.

Examples of NBR used for the specific rubber blend (A) are not specifically limited, those ordinarily used for fuel hoses may be used. However, especially, NBR containing bound acrylonitrile at an ordinary grade (27 wt % to 35 wt %) is preferred.

The specific rubber blend (A) needs to contain acrylonitrile (ACN) in an amount of 15 wt % to 30 wt %, as mentioned above. If the ACN amount in the rubber blend (A) is smaller than 15 wt %, the resulting rubber blend (A) tends to have deteriorated resistance to fuel oil. On the other hand, if the ACN amount in the rubber blend (A) is greater than 30 wt %, the resulting rubber blend (A) tends to have deteriorated low temperature properties.

The blend ratio (weight ratio) between the ACM and the NBR preferably is within the range of ACM:NBR=3:7 to 7:3. If the blend ratio of the ACM is lower than the above range (or the blend ratio of the NBR is over the above range), low temperature properties and sour gasoline resistance tend to be inferior. On the other hand, if the blend ratio of the ACM is greater than the above range (or the blend ratio of the NBR is less than the above range), resistance to fuel oil and adhesive property with resin tend to be inferior.

The specific acrylic rubber (B) for forming the innermost layer 1 is an acrylic rubber having a skeleton derived from acrylonitrile in its molecular skeleton. The specific acrylic rubber (B) contains a base material of an acrylic rubber obtained by copolymerizing alkoxyalkyl acrylate, acrylonitrile (at about 15 wt % to 30 wt %) and a crosslinkable monomer (at a required amount).

The alkoxyalkyl acrylate for the base material is not specifically limited, but methoxyethyl acrylate (MEA) or ethoxyethyl acrylate(EEA) is preferred in terms of their excellent low temperature properties, among which MEA is more preferred. These may be used either alone or in combination. The alkoxyalkyl acrylate may be contained in a proportion of 80 wt % to 90 wt % in the base material. The crosslinkable monomer is not specifically limited and its content is not specifically limited, however, it is preferred that epoxy crosslinkable monomer ordinarily used for an acrylic rubber is contained at 1 wt % to 5 wt % in the base material. Further, a crosslinking agent, capable of amine vulcanization, imidazole vulcanization, peroxide vulcanization and the like, may be appropriately added to the base material for the above-mentioned copolymerization. In addition, other kinds of ester monomer acrylate may be added into the base material, if it is a very small amount.

It is preferred that the content of acrylonitrile in the specific acrylic rubber (B) is within a range of 15 wt % to 30 wt %. When the content thereof is less than 15 wt %, resistance to fuel oil tends to deteriorate. On the other hand, when the content thereof is over 30 wt %, low temperature properties tend to deteriorate. Further, when the content thereof is over 35 wt %, crystallinity becomes very high, resulting in problems in terms of production.

Since the specific rubber blend (A) and the specific acrylic rubber (B) have good electrical conductivity, an electrically conductive agent such as carbon black may not be included according to the situation. However, generally, an electrically conductive agent may appropriately be added so as to obtain the desired electrical resistance. When an electrically conductive agent is added, the amount thereof may be reduced compared with the ordinary case. Therefore, the innermost layer 1 may not be deteriorated in its mechanical strength and the like, so that excellent sealing property may be realized and the resulting hose has the desired electrical resistance.

The innermost layer 1 made of the specific rubber blend (A) or the specific acrylic rubber (B) may preferably have volume resistivity of not more than 10⁸Ω·cm, more preferably of not more than 10⁵Ω·cm. The electrically conductive agent may be added such that the volume resistivity of the innermost layer 1 is within the above-mentioned range. Generally, the electrically conductive agent may preferably be added at 10 to 80 parts by weight (just abbreviated as “parts” hereinafter) ,more preferably 20 to 70 parts, relative to 100 parts of the polymer rubber (the total amount of the rubber components).

The innermost layer 1 may contain a plasticizer such as an ether-ester type, an ether type and an ester type to appropriately provide sufficient low temperature properties. The mixing amount thereof may be reduced compared with the ordinary case because the mixing amount of electrically conductive agent such as carbon black may be reduced. Generally, the mixing amount of the plasticizer is preferably 0 to 30 parts, more preferably 5 to 20 parts, relative to 100 parts of the above-mentioned polymer rubber.

Further, the innermost layer 1 may appropriately contain one or more of a vulcanizing agent, a vulcanization accelerator, an antioxidant and the like, as required, in addition to the electrically conductive agent and the plasticizer, if desired. It is preferred that 1,8-diazabicyclo(5.4.0) undecene-7 salt (just abbreviated as “DBU salt” hereinafter) may be added as a material for the innermost layer for good adhesion with a fluororesin layer so as to have good interlaminar bonding therewith even without the use of an adhesive. Among all, a DBU salt of carboxylate or a DBU salt of phenol resin is preferred in terms of good adhesion with the fluororesin layer. Further, when silica is added as a material for the innermost layer 1, adhesion with the fluororesin is increased when being unvulcanized, resulting in stable adhesion. Therefore, silica may also be added thereto, appropriately.

The mixing ratio of the DBU salt is preferably 0.5 to 10 parts, more preferably 0.5 to 7 parts, relative to 100 parts of the polymer rubber. When the amount is within the above-mentioned range, sufficient adhesion with the fluororesin layer may be obtained while sustaining the mechanical strength of the innermost layer 1. When it is less than 0.5 parts, sufficient adhesion with the fluororesin layer may not be obtained. On the other hand, when it is over 10 parts, the mechanical strength of the innermost layer may tend to deteriorate.

A material of the fluororesin layer 2 formed on a peripheral surface of the innermost layer 1 is not specifically limited. Examples thereof include a copolymer of vinylidene fluoride and ethylene tetrafluoride, a copolymer of vinylidene fluoride and propylene hexafluoride, a terpolymer of vinylidene fluoride, ethylene tetrafluoride and propylene hexafluoride, a polymer wherein vinylidene fluoride is grafted onto a copolymer of vinylidene fluoride and propylene hexafluoride, vinylidene polyfluoride, a copolymer of ethylene and ethylene tetrafluoride, among which a copolymer of vinylidene fluoride and ethylene tetrafluoride, a copolymer of vinylidene fluoride and propylene hexafluoride, a terpolymer of vinylidene fluoride, ethylene tetrafluoride and propylene hexafluoride and a polymer wherein vinylidene fluoride is grafted onto a copolymer of vinylidene fluoride and propylene hexafluoride are particularly preferred. These are used either alone or in combination.

An outer layer 3 may be formed on a peripheral surface of the fluororesin layer 2 so as to impart abrasion resistance and the like to the hose. The material for forming the outer layer 3 may not be specifically limited. Examples thereof include hydrin rubber, chlorosulfonated polyethylene rubber and nitrile-vinyl chloride rubber.

The inventive fuel hose as shown in the FIGURE may be produced, for example, by the following manner.

Each material for the innermost layer 1, the fluororesin layer 2 and the outer layer 3 is prepared and in turn is kneaded by means of a kneader, respectively. Then, each material for these three layers is extruded at the same time by means of an extruder, respectively, so as to obtain the intended three-layer structured fuel hose (see the FIGURE). Thus, each interface of these three layers is strongly bonded each other so as to be integrally laminated, even without the use of an adhesive.

Further, a hose may be formed into a straight shape by means of a vacuum sizing method or may be formed into a bellows structure by means of a corrugator.

The method for producing the inventive hose shown in the FIGURE is not specifically limited to the method by simultaneously extruding each material by means of an extruder. For example, a material for the innermost layer 1 may be first kneaded by means of a kneader, and then extruded by means of an extruder for producing a hose having a single layer structure. Then, each material for the fluororesin layer 2 and the outer layer 3 is extruded successively by means of an extruder so that the intended hose having a three-layer structure maybe obtained. Generally, each interface therebetween may be adhered each other without the use of an adhesive, however, an adhesive may be used as an adjuvant, according to the case.

The thus obtained hose may preferably have an inner diameter of 4 to 50 mm, more preferably, 4 to 45 mm and may preferably have an outer diameter of 6.1 to 63 mm, more preferably, 6.2 to 53.6 mm. Further, the innermost layer 1 may preferably have a thickness of 0.5 to 3 mm, more preferably 0.5 to 2mm, the fluororesin layer 2 may preferably have a thickness of 0.05 to 0.5 mm, more preferably, 0.1 to 0.3 mm, and the outer layer 3 may preferably have a thickness of 0.5 to 3 mm, more preferably, 0.5 to 2 mm.

Further, the hose shown in the FIGURE has a three layer structure. However, since a noticeable characteristic of the present invention is a laminated structure of an innermost layer made of the specific material and the fluororesin layer formed on a peripheral surface of the innermost layer, other layers are optional. Furthermore, the material of the outer layer is not limited to a rubber material, as mentioned above. In addition, for example, the inventive hose may have a multi-layer (four or more layers) structure by forming one or more intermediate layer(s) , such as an intermediate rubber layer, a polyester resin layer, a reinforcing layer, a reinforcing wire layer so as to be intervened between the fluororesin layer 2 and the outer layer 3.

The inventive hose is preferably used as an automotive fuel hose, however, the use is not limited thereto. For example, the inventive hose may be used as a hose for use in an agricultural vehicle such as a tractor or a cultivator.

Next, explanation will be given to Examples 1 to 3 using the specific rubber blend (A) for the innermost layer and Examples 4 to 8 using the specific acrylic rubber (B) for the innermost layer with reference to Comparative Examples 1 to 6.

### EXAMPLE 1

[Preparation of Innermost Layer]

A material for an innermost layer was prepared by kneading 40 parts of ACM (DENKA ER-3400, available from DENKI KAGAKU KOGYO KABUSHIKI KAISHA), 60 parts of NBR (Nipol DN202 available from Zeon Corporation, bound acrylonitrile amount: 31 wt %), 50 parts of carbon black (SEAST 116, available from Tokai Carbon, Co., Ltd.), 1 part of a DBU salt (DA-500, available from Daiso Co., Ltd.), 1 part of a processing aid (LUNAC S-30, available from KAO Corporation), 20 parts of silica (Carplex 1120, available from SHIONOGI & CO., LTD.), 10 parts of a plasticizer (ADECASIZER RS-107, available from Asahi Denka Co., Ltd.), 2 parts of a vulcanizing agent (CN-25, available from DENKI KAGAKU KOGYO KABUSHIKI KAISHA), 0.5 parts of sulfur and 0.3 parts of a vulcanization accelerator aid (VULNOCAB-S, available from Ouchi Shinko Chemical Industrial Co., Ltd.) by means of a kneader. Thus obtained polymer rubber as a material for the innermost layer contained acrylonitrile at 18.6 wt %.

[Material for Intermediate Layer]

Fluororesin (THV-500G, available from Dyneon)

[Material for Outermost Layer]

A material for an outermost layer was prepared by kneading 100 parts of hydrin rubber (EPICHLOMER CG, available from Daiso Co., Ltd.), 1.5 parts of a vulcanization accelerator aid (Kyowa Mag#150, available from Kyowa Chemical Industry Co., Ltd.), 50 parts of carbon black (SEAST SO, available from Tokai Carbon Co., Ltd.), 10 parts of a plasticizer (DOP, available from Daihachi Chemical Industry Co., Ltd., 1 part of an antioxidant (NOCRAC NBC, available from Ouchi Shinko Chemical Industrial Co., Ltd.), 1 part of a DBU salt (DA-500, available from Daiso Co., Ltd.), a vulcanizing agent (0.6parts of SANCELER-22-C, available from Sanshin Chemical Industries and 1 part of REVITALMASTER P-CHR-1100 available from Zeon KASEI Co., Ltd.) by means of a kneader.

[Production of Hose]

Each material was preliminarily prepared, as mentioned above, and kneaded by means of a kneader, respectively, and in turn extruded simultaneously by means of an extruder. Thus obtained hose having a three-layer structure had an innermost layer of 1 mm thickness, an intermediate layer of 0.2 mm thickness, and an outermost layer of 2 mm thickness, and also an inner diameter of 22 mm and an outer diameter of 28.4 mm.

### EXAMPLE 2

A material for an innermost layer was prepared by kneading 30 parts of ACM (DENKA ER-3400, available from DENKI KAGAKU KOGYO KABUSHIKI KAISHA), 70 parts of NBR (Nipol DN101, available from Zeon Corporation, bound acrylonitrile amount: 42.5wt %), 50 parts of carbon black (SEAST 116, available from Tokai Carbon, Co., Ltd.), 1 part of DBU salt (DA-500, available from Daiso Co., Ltd.), 1 part of processing aid (LUNAC S-30, available from KAO Corporation), 20parts of silica (Carplex 1120, available from SHIONOGI & CO., LTD.), 10 parts of a plasticizer (ADECASIZERRS-107, available from Asahi Denka Co., Ltd.), 2 parts of a vulcanizing agent (CN-25, available from DENKI KAGAKU KOGYO KABUSHIKI KAISHA), 0.5 parts of sulfur and 0.3 parts of a vulcanization accelerator aid (VULNOC AB-S, available from Ouchi Shinko Chemical Industrial Co., Ltd.) by means of a kneader. The thus obtained polymer rubber as a material for the innermost layer contained acrylonitrile at 29.8 wt %. Except for the material of the innermost layer, the fuel hose having a three-layer structure was produced by the same method as in Example 1.

### EXAMPLE 3

A material for an innermost layer was prepared by kneading 70 parts of ACM (DENKA ER-3400, available from DENKI KAGAKU KOGYO KABUSHIKI KAISHA), 30 parts of NBR (Nipol DN009, available from Zeon Corporation, bound acrylonitrile amount: 50 wt %), 50 parts of carbon black (SEAST 116, available from Tokai Carbon, Co., Ltd.), 1 part of a DBU salt (DA-500, available from Daiso Co., Ltd.), 1 part of a processing aid (LUNAC S-30, available from KAO Corporation), 20 parts of silica (Carplex 1120, available from SHIONOGI & CO., LTD.), 10 parts of a plasticizer (ADECASIZER RS-107, available from Asahi Denka Co., Ltd.), 2 parts of a vulcanizing agent (CN-25, available from, DENKI KAGAKU KOGYO KABUSHIKI KAISHA), 0.5 parts of sulfur and 0.3 parts of a vulcanization accelerator aid (VULNOCAB-S, available from Ouchi Shinko Chemical Industrial Co., Ltd.) by means of a kneader. The thus obtained polymer rubber as a material for the innermost layer contained acrylonitrile at 15 wt %. Except for the material of the innermost layer, the fuel hose having a three-layer structure was produced by the same method as in Example 1.

### EXAMPLE 4

A material for an innermost layer was prepared by kneading 100 parts of an acrylic rubber having acrylonitrile in its molecular skeleton (content of acrylonitrile: 15.0 wt %), 50 parts of carbon black (SEAST 116, available from Tokai Carbon Co., Ltd.), 1 part of a DBU salt (DA-500, available from Daiso Co., Ltd.), 1 part of a processing aid (LUNAC S-30, available from KAO Corporation), 10 parts of a plasticizer (ADECASIZER RS-107, available from Asahi Denka Co., Ltd.), 2 parts of a vulcanizing agent (CN-25, available from DENKI KAGAKU KOGYO KABUSHIKI KAISHA) and 0.3 parts of a vulcanization accelerator aid (VULNOCAB-S, available from Ouchi Shinko Chemical Industrial Co., Ltd.) by means of a kneader. Except for the material of the innermost layer, the fuel hose having a three-layer structure was produced by the same method as in Example 1.

### EXAMPLE 5

A material for an innermost layer was prepared by kneading 100 parts of an acrylic rubber having acrylonitrile in its molecular skeleton (content of acrylonitrile: 25.0 wt %), 50 parts of carbon black (SEAST 116, available from Tokai Carbon Co., Ltd.), 1 part of a DBU salt (DA-500, available from Daiso Co., Ltd.), 1 part of a processing aid (LUNAC S-30, available from KAO Corporation), 10 parts of a plasticizer (ADECASIZER RS-107, available from Asahi Denka Co., Ltd.), 2 parts of a vulcanizing agent (CN-25, available from DENKI KAGAKU KOGYO KABUSHIKI KAISHA) and 0.3 parts of a vulcanization accelerator aid (VULNOCAB-S, available from Ouchi Shinko Chemical Industrial Co., Ltd.) by means of a kneader. Except for the material of the innermost layer, the fuel hose having a three-layer structure was produced by the same method as in Example 1.

### EXAMPLE 6

A material for an innermost layer was prepared by kneading 100 parts of an acrylic rubber having acrylonitrile in its molecular skeleton (content of acrylonitrile: 30.0 wt %), 50 parts of carbon black (SEAST 116, available from Tokai Carbon Co., Ltd.), 1 part of a DBU salt (DA-500, available from Daiso Co., Ltd.) , 1 part of a processing aid (LUNAC S-30, available from KAO Corporation), 10 parts of a plasticizer (ADECASIZER RS-107, available from Asahi Denka Co., Ltd.), 2 parts of a vulcanizing agent (CN-25, available from DENKI KAGAKU KOGYO KABUSHIKI KAISHA) and 0.3 parts of a vulcanization accelerator aid (VULNOCAB-S, available from Ouchi Shinko Chemical Industrial Co., Ltd.) by means of a kneader. Except for the material of the innermost layer, the fuel hose having a three-layer structure was produced by the same method as in Example 1.

### EXAMPLE 7

A material for an innermost layer was prepared by kneading 100 parts of an acrylic rubber having acrylonitrile in its molecular skeleton (content of acrylonitrile: 25.0 wt %), 50 parts of carbon black (SEAST 116, available from Tokai Carbon Co., Ltd.), 1 part of a DBU salt (DA-500, available from Daiso Co., Ltd.), 1 part of a processing aid (LUNAC S-30, available from KAO Corporation), 20parts of silica (Carplex1120, available from SHIONOGI & CO., LTD.), 10 parts of a plasticizer (ADECASIZERRS-107, available from Asahi Denka Co., Ltd.), 2 parts of a vulcanizing agent (CN-25, available from DENKI KAGAKU KOGYO KABUSHIKI KAISHA) and 0.3 parts of a vulcanization accelerator aid (VULNOC AB-S, available from Ouchi Shinko Chemical Industrial Co., Ltd.) by means of a kneader. Except for the material of the innermost layer, the fuel hose having a three-layer structure was produced by the same method as in Example 1.

### EXAMPLE 8

A material for an innermost layer was prepared by kneading 100 parts of an acrylic rubber having acrylonitrile in its molecular skeleton (content of acrylonitrile: 10.0 wt %), 50 parts of carbon black (SEAST 116, available from Tokai Carbon Co., Ltd.), 1 part of a DBU salt (DA-500, available from Daiso Co., Ltd.), 1 part of a processing aid (LUNAC S-30, available from KAO Corporation), 10 parts of a plasticizer (ADECASIZER RS-107, available from Asahi Denka Co., Ltd.), 2 parts of a vulcanizing agent (CN-25, available from DENKI KAGAKU KOGYO KABUSHIKI KAISHA) and 0.3 parts of a vulcanization accelerator aid (VULNOCAB-S, available from Ouchi Shinko Chemical Industrial Co., Ltd.) by means of a kneader. Except for the material of the innermost layer, the fuel hose having a three-layer structure was produced by the same method as in Example 1.

### COMPARATIVE EXAMPLE 1

A material for an innermost layer was prepared by kneading 100 parts of ACM not containing acrylonitrile (DENKA ER-3400, available from DENKI KAGAKU KOGYO KABUSHIKI KAISHA) , 50 parts of carbon black (SEAST 116, available from Tokai Carbon, Co., Ltd.), 1 part of a processing aid (LUNAC S-30, available from KAO Corporation), 20parts of silica (Carplex1120, available from SHIONOGI & CO., LTD.), 10 parts of a plasticizer (ADECASIZERRS-107, available from Asahi Denka Co., Ltd.), 2 parts of a vulcanizing agent (CN-25, available from DENKI KAGAKU KOGYO KABUSHIKI KAISHA), 0.3 parts of a vulcanization accelerator aid (VULNOC AB-S, available from Ouchi Shinko Chemical Industrial Co., Ltd.) by means of a kneader. Except for the material of the innermost layer, the fuel hose having a three-layer structure was produced by the same method as in Example 1.

### COMPARATIVE EXAMPLE 2

A material for the innermost layer was prepared by kneading 100 parts of NBR (Nipol DN-202, available from Zeon Corporation), 30 parts of carbon black (SEAST 116, available from Tokai Carbon, Co., Ltd.), 1 part of a processing aid (LUNAC S-30, available from KAO Corporation), 20 parts of silica (Carplex1120, available from SHIONOGI & CO., LTD.), 15 parts of a plasticizer (DOP, available from Daihachi Chemical Industry Co., Ltd.), 1 part of an antioxidant (NOCRAC NBC, available from Ouchi Shinko Chemical Industrial Co., Ltd.), 1 part of a DBU salt (DA-500, available from Daiso Co., Ltd.), 5 parts of a vulcanization accelerator (2 kinds of zinc oxide, available from Mitsui Mining & Smelting Co., Ltd.) and 5 parts of a vulcanizing agent (PERKMYL D-40, available from NOF CORPORATION) by means of a kneader. The thus obtained polymer rubber as a material for the innermost layer contained acrylonitrile at 31.0 wt %. Except for the material of the innermost layer, the fuel hose having a three-layer structure was produced by the same method as in Example 1.

### COMPARATIVE EXAMPLE 3

A material for an innermost layer was prepared by kneading 100 parts of NBR PVC (NV-72, available from JSR Corporation), 30 parts of carbon black (SEAST 116, available from Tokai Carbon, Co., Ltd.), 1 part of a processing aid (LUNAC S-30, available from KAO Corporation), 20 parts of silica (Carplex1120, available from SHIONOGI & CO., LTD.), 15 parts of a plasticizer (DOP, available from Daihachi Chemical Industry Co., Ltd.), 1 part of an antioxidant (NOCRAC NBC, available from Ouchi Shinko Chemical Industrial Co., Ltd.), 1 part of a DBU salt (DA-500, available from Daiso Co., Ltd.), 5 parts of a vulcanization accelerator (2 kinds of zinc oxide, available from Mitsui Mining & Smelting Co., Ltd.) and 5 parts of a vulcanizing agent (PERKMYL D-40, available from NOF CORPORATION) by means of a kneader. The thus obtained polymer rubber as a material for the innermost layer contained acrylonitrile at 24.5 wt %. Except for the material of the innermost layer, the fuel hose having a three-layer structure was produced by the same method as in Example 1.

### COMPARATIVE EXAMPLE 4

A material for the innermost layer was prepared by kneading 100 parts of FKM (Fluorel FE5731Q, available from SUMITOMO 3M LTD.), 15 parts of carbon black (SEAST S, available from Tokai Carbon, Co., Ltd.), 3 parts of magnesium hydroxide (KyowaMag#150, available from Kyowa Chemical Industry Co., Ltd.) and 6 parts of calcium hydroxide (Cal-Z, available from Ohmi Kagaku Corporation) by means of a kneader. Except for the material of the innermost layer, the fuel hose having a three-layer structure was produced by the same method as in Example 1.

### COMPARATIVE EXAMPLE 5

A material for an innermost layer was prepared by kneading 25 parts of ACM (DENKA ER-3400, available from DENKI KAGAKU KOGYO KABUSHIKI KAISHA), 75 parts of NBR (Nipol DN101 available from Zeon Corporation, bound acrylonitrile amount: 42.5 wt %), 50 parts of carbon black (SEAST 116, available from Tokai Carbon, Co., Ltd.), 1 part of a DBU salt (DA-500, available from Daiso Co., Ltd.), 1 part of a processing aid (LUNAC S-30, available from KAO Corporation), 20 parts of silica (Carplex 1120, available from SHIONOGI & CO., LTD.), 10 parts of a plasticizer (ADECASIZER RS107, available from Asahi Denka Co., Ltd.), 2 parts of a vulcanizing agent (CN-25, available from DENKI KAGAKU KOGYO KABUSHIKI KAISHA), 0.5 parts of sulfur and 0.3 parts of a vulcanization accelerator aid (VULNOCAB-S, available from Ouchi Shinko Chemical Industrial Co., Ltd.) by means of a kneader. The thus obtained polymer rubber as a material for the innermost layer contained acrylonitrile at 31.9 wt %. Except for the material of the innermost layer, the fuel hose having a three-layer structure was produced by the same method as in Example 1.

### COMPARATIVE EXAMPLE 6

A material for an innermost layer was prepared by kneading 75 parts of ACM (DENKA ER-3400, available from DENKI KAGAKU KOGYO KABUSHIKI KAISHA), 25 parts of NBR (Nipol DN009, available from Zeon Corporation, bound acrylonitrile amount: 50 wt %), 50 parts of carbon black (SEAST 116, available from Tokai Carbon, Co., Ltd.), 1 part of a DBU salt (DA-500, available from Daiso Co., Ltd.), 1 part of a processing aid (LUNAC S-30, available from KAO Corporation), 20 parts of silica (Carplex 1120, available from SHIONOGI & CO., LTD.), 10 parts of a plasticizer (ADECASIZER RS-107, available from Asahi Denka Co., Ltd.), 2 parts of a vulcanizing agent (CN-25, available from DENKI KAGAKU KOGYO KABUSHIKI KAISHA), 0.5 parts of sulfur and 0.3 parts of a vulcanization accelerator aid (VULNOCAB-S, available from Ouchi Shinko Chemical Industrial Co., Ltd.) by means of a kneader. The thus obtained polymer rubber as a material for the innermost layer contained acrylonitrile at 12.5 wt %. Except for the material of the innermost layer, the fuel hose having a three-layer structure was produced by the same method as in Example 1.

The fuel hoses (or the vulcanized sheets each having a 2 mm thickness obtained by press-vulcanizing each material for an innermost layer at 160° C. for 45 minutes) of the Examples and the Comparative Examples thus produced were evaluated for characteristic properties thereof in the following manners. The results of the evaluations are shown in Tables 1 to 3.

Volume Resistivity of Innermost Layer

Each volume resistivity (Ω·cm) of each vulcanized sheet was determined according to Japanese Industrial Standard (JIS) K 6271.

Tensile Strength at Break (TB) and Elongation at Break (EB)

Each vulcanized sheet was punched out using the JIS No. 5 dumbbell to evaluate TB and EB according to JIS K 6251.

Interlaminar Bonding Property

Each hose was cut in halves with 100 mm length longitudinally. Each of the thus obtained specimens was pulled from the innermost layer side at a rate of 50 mm/min. by means of a tensile tester (JIS B 7721) for evaluation of adhesion between the innermost layer and the intermediate layer. The interface was visually inspected for evaluating the peeling status of the layers. When the innermost layer was stripped off by the intermediate layer, the hose was graded as “good” (◯) in Tables 1 to 3. When the layers were peeled at the interface, the hose was graded as “poor” (×) in Tables 1 to 3.

Sour Gasoline Resistance

A specimen cut from each innermost layer was dipped twice into a mixture prepared by blending 2.5 wt % of lauroyl peroxide (LPO) in Fuel C (50 vol % of toluene and 50 vol % of isooctane) at 40° C. for 72 hours. In Tables 1 to 3, the symbol ◯ indicates that no abnormality such as hardening or softening was observed, and the symbol × indicates that such an abnormality was observed.

Resistance to Fuel Oil

A specimen cut from each innermost layer was dipped into Fuel C at 40° C. for 48 hours. Each volume change rate (%) was evaluated. In Tables 1 to 3, the symbol ◯ indicates that the volume change rate was less than 30% and a symbol × indicates that the volume change was not less than 30%.

Amine Resistance

A degraded model gasoline was prepared by mixing 0.005 mol/L of dodecamethylenediamine with Fuel C. A specimen cut from each innermost layer was dipped into the model gasoline at 80° C. for 72 hours. In Tables 1 to 3, the symbol ◯ indicates that no abnormality such as hardening or softening was observed, and the symbol X indicates that such an abnormality was observed.

Low Temperature Properties

Each low temperature brittle point was determined by a low temperature impact resistance test on each vulcanized sheet of the innermost layer according to JIS K6261. In Tables 1 to 3, the symbol ◯ indicates that the low temperature brittle point was less than −25° C. and the symbol × indicates that the low temperature brittle point was not less than −25° C.

TABLE 1

| | Example | | |
|---|---|---|---|
| | 1 | 2 | 3 |
| Content of acrylonitrile (wt %) | 18.6 | 29.8 | 15.0 |
| Resistance of innermost layer | 2 × 10⁵ | 9 × 10⁶ | 5 × 10³ |
| (Ω · cm) | | | |
| TB (MPa) | 9.8 | 11.3 | 10.1 |
| EB (%) | 350 | 380 | 340 |
| Interlaminar adhesion | ∘ | ∘ | ∘ |
| Sour gasoline resistance | ∘ | ∘ | ∘ |
| Resistance to fuel oil | ∘ | ∘ | ∘ |
| Amine resistance | ∘ | ∘ | ∘ |
| Low temperature properties | ∘ | ∘ | ∘ |

TABLE 2

| | Example | | | | |
|---|---|---|---|---|---|
| | 4 | 5 | 6 | 7 | 8 |
| Content of acrylonitrile | 15.0 | 25.0 | 30.0 | 25.0 | 10.0 |
| (wt %) | | | | | |
| Resistance of innermost | 6 × 10³ | 4 × 10³ | 3 × 10³ | 5 × 10⁴ | 7 × 10³ |
| layer (Ω · cm) | | | | | |
| TB (MPa) | 10.3 | 10.8 | 11.1 | 10.3 | 10.2 |
| EB (%) | 390 | 390 | 380 | 340 | 400 |
| Interlaminar adhesion | ∘ | ∘ | ∘ | ∘ | ∘ |
| Sour gasoline resistance | ∘ | ∘ | ∘ | ∘ | ∘ |
| Resistance to fuel oil | ∘ | ∘ | ∘ | ∘ | ∘ |
| Amine resistance | ∘ | ∘ | ∘ | ∘ | ∘ |
| Low temperature | ∘ | ∘ | ∘ | ∘ | ∘ |
| properties | | | | | |

TABLE 3

| | Comparative Example | | | | | |
|---|---|---|---|---|---|---|
| | 1 | 2 | 3 | 4 | 5 | 6 |
| Content of | 0 | 31.0 | 24.5 | 0 | 31.9 | 12.5 |
| acrylonitrile | | | | | | |
| (wt %) | | | | | | |
| Resistance of | 7 × 10² | 6 × 10⁸ | 4 × 10⁹ | 2 × 10¹¹ | 2 × 10⁷ | 2 × 10³ |
| innermost | | | | | | |
| layer | | | | | | |
| (Ω · cm) | | | | | | |
| TB (MPa) | 10.0 | 12.2 | 13.7 | 12.5 | 11.0 | 9.5 |
| EB (%) | 410 | 500 | 400 | 350 | 360 | 330 |
| Interlaminar | ∘ | ∘ | ∘ | x | ∘ | ∘ |
| adhesion | | | | | | |
| Sour | ∘ | x | x | ∘ | x | ∘ |
| gasoline | | | | | | |
| resistance | | | | | | |
| Resistance to | x | ∘ | ∘ | ∘ | ∘ | x |
| fuel oil | | | | | | |
| Amine | ∘ | ∘ | ∘ | x | ∘ | ∘ |
| resistance | | | | | | |
| Low | ∘ | ∘ | x | x | x | ∘ |
| temperature | | | | | | |
| properties | | | | | | |

As can be understood from the results shown in Tables 1 to 3, all of the Examples had excellent electrical conductivity and strong interlaminar adhesion, and also had good sour gasoline resistance, resistance to fuel oil, amine resistance and low temperature properties.

On the contrary, since the innermost layer of Comparative Example 1 was made of the ordinary ACM not containing acrylonitrile, resistance to fuel oil was poor. The innermost layer of Comparative Example 2 was made of only NBR, sour gasoline resistance and electrical conductivity were poor. Since the innermost layer of Comparative Example 3 was made of NBR•PVC, sour gasoline resistance, low temperature properties and electrical conductivity were inferior to the Examples. Since the innermost layer of Comparative Example 4 was made of FKM, amine resistance, low temperature properties, electrical conductivity and interlaminar adhesion were poor. Since the innermost layer of Comparative Example 5was made of a polymer blend of ACM and NBR, which, however, contained acrylonitrile over the specified range according to the present invention, electrical conductivity was slightly inferior, and sour gasoline resistance and low temperature properties were inferior. Since the content of acrylonitrile of Comparative Example 6 was less than the above-mentioned specified range, resistance to a fuel oil was inferior.

As mentioned above, the inventive hose has a laminate structure comprising an innermost layer made of a rubber blend (of an acrylic rubber and an acrylonitrile-butadiene rubber) containing acrylonitrile derived from NBR within a specific range or an acrylic rubber having a skeleton derived from acrylonitrile in its molecular skeleton, and a fluororesin layer formed on a peripheral surface on the innermost layer. Therefore, adhesion between the innermost rubber layer and the fluororesin layer is good. Further, since the inventive hose has excellent permeation resistance to gasoline, sour gasoline resistance, amine resistance and low temperature properties, and has excellent electrical conductivity, the hose can work efficiently as an automotive hose. Still further, since carbon black or the like for the innermost layer may not be required or the blending amount thereof may be reduced due to its good electrical conductivity, the sealing property is good, which may help efficiently prevent leakage of fuel or the like. Even still further, since a plasticizer for the innermost layer may not be required or the blending amount thereof may be reduced, the bleeding property may be improved. Then, when blending materials for the innermost layer, discretion of blending may be widened.

Especially, when the blend ratio of the acrylic rubber and NBR for the rubber blend of the innermost layer is within the specific range, low temperature properties, sour gasoline resistance, resistance to fuel oil and the like are effectively realized.

On the other hand, when the content of the acrylonitrile of the specific acrylic rubber of the innermost layer is within the specific range, low temperature properties, sour gasoline resistance, resistance to fuel oil and the like are effectively realized.

Further, when 1,8-diazabicyclo(5.4.0) undecene-7 salt is contained in the material of the innermost layer, adhesion with the fluororesin layer is good so that interlaminar adhesion is excellent without the use of an adhesive. Still further, when silica is contained therein, adhesion with the fluororesin layer in the unvulcanized state is increased, resulting in stable adhesion.

1. A fuel hose having a laminate structure comprising an innermost layer of a material including the following (A) and a fluororesin layer formed on a peripheral surface of the innermost layer:
(A) a rubber blend of an acrylic rubber and an acrylonitrile-butadiene rubber wherein acrylonitrile is present in a proportion of 15 wt % to 30 wt %.

2. A fuel hose as set forth in claim 1, wherein the acrylic rubber (ACM) and the acrylonitrile-butadiene rubber (NBR) are present in a weight ratio of ACM:NBR=3:7 to 7:3 in the polymer blend (A).

3. A fuel hose as set forth in claim 1, wherein the material of the innermost layer further comprises 1,8-diazabicyclo(5.4.0) undecene-7 salt.

4. A fuel hose as set forth in claim 2, wherein the material of the innermost layer further comprises 1,8-diazabicyclo(5.4.0) undecene-7 salt.

5. A fuel hose having a laminate structure comprising an innermost layer of a material including the following (B) and a fluororesin layer formed on a peripheral surface of the innermost layer:
(B) an acrylic rubber having a skeleton derived from acrylonitrile in its molecular skeleton.

6. A fuel hose as set forth in claim 5, wherein acrylonitrile is present in a proportion of 15 wt % to 30 wt % in the acrylic rubber (B).

7. A fuel hose as set forth in claim 5, wherein the material of the innermost layer further comprises 1,8-diazabicyclo(5.4.0) undecene-7 salt.

8. A fuel hose as set forth in claim 6, wherein the material of the innermost layer further comprises 1,8-diazabicyclo(5.4.0) undecene-7 salt.
